(19) United States
(12) Patent Application Publication
(10) Pub. No.: US 2025/0145501 A1
(43) Pub. Date: May 8, 2025

(54) APPARATUS, SYSTEM AND METHOD FOR PFAS REMOVAL AND MINERALIZATION

(71) Applicant: Evoqua Water Technologies LLC, Pittsburgh, PA (US)

(72) Inventors: Gary C. Ganzi, Lexington, MA (US); Frederick Wilkins, Pepperell, MA (US)

(21) Appl. No.: 18/838,407

(22) PCT Filed: Feb. 14, 2023
(86) PCT No.: PCT/US2023/013012

§ 371 Date: Aug. 14, 2024

Related U.S. Application Data
(60) Provisional application No. 63/309,665, filed on Feb. 14, 2022.

(51) Int. Cl. C02F 1/28; B01D 15/42; B01D 53/94; B01J 20/20; B01J 20/34; C02F 1/24; C02F 1/42; C02F 101/36; F01N 3/00

(52) U.S. Cl. CPC C02F 1/283; B01D 15/426; B01D 53/94; B01J 20/20; B01J 20/3416; B01J 20/3458; B01J 20/3475; C02F 1/24; C02F 1/42; F01N 3/005; C02F 2101/36; C02F 2101/40; C02F 2303/16; C02F 2305/04

(57) ABSTRACT

Systems and methods for treating water containing PFAS are disclosed. Adsorption media may be used to remove PFAS from water. An eluent may release PFAS from loaded adsorption media to form a waste stream. An internal combustion engine may be used to mineralize PFAS in the waste stream.

### CROSS-REFERENCE TO RELATED APPLICATION

This application is a national stage application of, and claims priority to, International Application No. PCT/US2023/013012, filed on Feb. 14, 2023, which claims priority to U.S. Provisional Patent Application Ser. No. 63/309,665, filed on Feb. 14, 2022, both titled “APPARATUS, SYSTEM AND METHOD FOR PFAS REMOVAL AND MINERALIZATION,” the entire disclosures of which are hereby incorporated herein by reference in their entirety for all purposes.

### FIELD OF TECHNOLOGY

Aspects and embodiments disclosed herein are generally related to the removal and elimination of per-and polyfluoroalkyl substances (PFAS) from water.

### BACKGROUND

There is rising concern about the presence of various contaminants in municipal wastewater, surface water, drinking water and groundwater. For example, perchlorate ions in water are of concern, as well as PFAS and PFAS precursors, along with a general concern with respect to total organic carbon (TOC).

PFAS are man-made chemicals used in numerous industries. PFAS molecules typically do not break down naturally. As a result, PFAS molecules accumulate in the environment and within the human body. PFAS molecules contaminate food products, commercial household and workplace products, municipal water, agricultural soil and irrigation water, and even drinking water. PFAS molecules have been shown to cause adverse health effects in humans and animals.

The U.S. Environmental Protection Agency (EPA) has issued a Contaminant Candidate List (CCL 5) which includes PFAS as a broad class inclusive of any PFAS that fits the revised CCL 5 structural definition of per- and polyfluoroalkyl substances (PFAS), namely chemicals that contain at least one of the following three structures:
R—(CF2)—CF(R′)R″, where both the CF2 and CF moieties are saturated carbons, and none of the R groups can be hydrogen.
R—CF2OCF2—R′, where both the CF2 moieties are saturated carbons, and none of the R groups can be hydrogen.
CF3C(CF3)RR′, where all the carbons are saturated, and none of the R groups can be hydrogen.

The EPA's Comptox Database includes a CCL 5 PFAS list of over 10,000 PFAS substances that meet the Final CCL 5 PFAS definition. The EPA has committed to being proactive as emerging PFAS contaminants or contaminant groups continue to be identified and the term PFAS as used herein is intended to be all inclusive in this regard.

### SUMMARY

In accordance with one or more aspects, a method of treating water containing a per- or poly-fluoroalkyl substance (PFAS) is disclosed. The method may comprise introducing water containing PFAS to an adsorption media to promote loading of the adsorption media with PFAS, introducing an eluent to the adsorption media containing PFAS to produce a waste stream containing PFAS, and directing the waste stream containing PFAS to an internal combustion engine with a source of oxygen and a source of fuel to promote mineralization of the PFAS.

The PFAS may comprise perfluorooctane sulfonic acid (PFOS), perfluorooctanoic acid (PFOA), or a perfluoroalkyl ether carboxylic acid.

In some aspects, the internal combustion engine may be operated at a process temperature of at least about 1000° C. The internal combustion engine may be operated at a process temperature of at least about 1500° C.

In some aspects, the adsorption media may comprise granular activated carbon (GAC). The adsorption media may be coated with a positively charged surfactant. In other aspects, the adsorption media may comprise ion exchange resin. The method may further comprise reactivating or regenerating the adsorption media. The method may still further comprise reusing the reactivated or regenerated adsorption media.

In some aspects, the method may further comprise concentrating or dewatering the waste stream containing prior to directing the waste stream to the internal combustion engine. The waste stream may be subjected to a foam fractionation process. The waste stream containing PFAS may be atomized into the internal combustion engine. The method may further comprise adjusting a pH level of the eluent or the waste stream to a level of greater than about 7 upstream of the internal combustion engine.

In some aspects, the eluent may be a water-soluble volatile compound. In some specific aspects, the eluent may be a cyclodextrin. In other aspects, the eluent may be supercritical carbon dioxide. In still other aspects, the eluent may be a flammable solvent. For example, the flammable solvent may comprise methanol.

In some aspects, the method may further comprise directing an exhaust stream associated with the internal combustion engine to a catalytic converter. The exhaust stream associated with the internal combustion engine may be polished. In some aspects, polishing may comprise directing the exhaust stream to a thermal oxidizer or a polishing sorbent unit operation.

In some aspects, the method may further comprise driving an electric generator via operation of the internal combustion engine.

In some aspects, the source of oxygen may be enriched. The source of fuel may comprise natural gas, propane, gasoline, diesel fuel or bio-diesel fuel. The source of fuel may be supplemented to inhibit corrosion of cylinders associated with the internal combustion engine. For example, ammonia may be added to the source of fuel.

In some aspects, the method may be associated with a PFAS removal rate of at least about 99%.

In accordance with one or more aspects, a system for treating water containing per-or polyfluoroalkyl substances (PFAS) is disclosed. The system may comprise a contact reactor containing adsorption media, the contact reactor having a first inlet fluidly connectable to a source of water comprising PFAS, a second inlet fluidly connectable to a source of an eluent, a treated water outlet, and a waste stream outlet. The system may further comprise an internal combustion engine fluidly connected downstream of the waste stream outlet of the contact reactor.

In some aspects, the system may further comprise a subsystem for concentrating the waste stream upstream of at least one of the contact reactor and the internal combustion engine.

In some aspects, the internal combustion engine may include a waste stream inlet, a fuel inlet and an oxygen inlet. The system may further comprise an atomizer in communication with the waste stream inlet. The system may further comprise an oxygen enrichment unit operation upstream of the oxygen inlet.

In some aspects, the system may further comprise a generator in electrical communication with the internal combustion engine.

In some aspects, the internal combustion engine may be constructed and arranged to operate at a process temperature in the range of about 1000° C. to about 2000° C. The internal combustion engine may be constructed and arranged to provide a residence time which exceeds a PFAS destruction requirement.

In some aspects, the adsorption media may comprise granular activated carbon (GAC) or ion exchange resin. The system may further comprise a spent adsorption media regeneration subsystem.

In some aspects, the system may further comprise a polishing subsystem downstream of the internal combustion engine. The polishing subsystem may comprise a thermal oxidizer or a polishing sorbent unit operation.

In some aspects, the system may be associated with a PFAS removal rate of at least about 99%.

The disclosure contemplates all combinations of any one or more of the foregoing aspects and/or embodiments, as well as combinations with any one or more of the embodiments set forth in the detailed description and any examples.

### BRIEF DESCRIPTION OF THE DRAWINGS

The accompanying drawings are not intended to be drawn to scale. In the drawings, each identical or nearly identical component that is illustrated in the various figures is represented by a like numeral. For purposes of clarity, not every component may be labeled in every drawing. In the drawings:

FIG. 1 presents a process flow diagram associated with systems and methods for treating water containing a per-or poly-fluoroalkyl substance (PFAS) in accordance with one or more embodiments; and

FIG. 2 presents a modification of the process flow diagram of FIG. 1 incorporating a concentrating unit operation in accordance with one or more embodiments.

### DETAILED DESCRIPTION

In accordance with one or more embodiments, water containing a per- or poly-fluoroalkyl substance (PFAS) may be treated. Adsorption media may be loaded with PFAS and then an eluent may be introduced to produce a waste stream containing PFAS. The adsorption media may be reactivated or regenerated for reuse. The waste stream may be treated to eliminate PFAS prior to environmental discharge. Specifically, the PFAS may be mineralized via operation of an internal combustion engine. Beneficially, PFAS treatment may be performed in an efficient and effective manner as described further herein.

PFAS are organic compounds consisting of fluorine, carbon and heteroatoms such as oxygen, nitrogen and sulfur. PFAS is a broad class of molecules that further includes polyfluoroalkyl substances. PFAS are carbon chain molecules having carbon-fluorine bonds. Polyfluoroalkyl substances are carbon chain molecules having carbon-fluorine bonds and also carbon-hydrogen bonds. Common PFAS molecules include perfluorooctanoic acid (PFOA), perfluorooctanesulfonic acid (PFOS), and short-chain organofluorine chemical compounds, such as the ammonium salt of hexafluoropropylene oxide dimer acid (HFPO-DA) fluoride (also known as GenX). PFAS molecules typically have a tail with a hydrophobic end and an ionized end. The hydrophobicity of fluorocarbons and extreme electronegativity of fluorine give these and similar compounds unusual properties. Initially, many of these compounds were used as gases in the fabrication of integrated circuits. The ozone destroying properties of these molecules restricted their use and resulted in methods to prevent their release into the atmosphere. But other PFAS such as fluoro-surfactants have become increasingly popular. PFAS are commonly use as surface treatment/coatings in consumer products such as carpets, upholstery, stain resistant apparel, cookware, paper, packaging, and the like, and may also be found in chemicals used for chemical plating, electrolytes, lubricants, and the like, which may eventually end up in the water supply. Further, PFAS have been utilized as key ingredients in aqueous film forming foams (AFFFs). AFFFs have been the product of choice for firefighting at military and municipal fire training sites around the world. AFFFs have also been used extensively at oil and gas refineries for both fire training and firefighting exercises. AFFFs work by blanketing spilled oil/fuel, cooling the surface, and preventing re-ignition. PFAS in AFFFs have contaminated the groundwater at many of these sites and refineries, including more than 100 U.S. Air Force sites.

Although used in relatively small amounts, these compounds are readily released into the environment where their extreme hydrophobicity as well as negligible rates of natural decomposition results in environmental persistence and bioaccumulation. It appears as if even low levels of bioaccumulation may lead to serious health consequences for contaminated animals such as human beings, the young being especially susceptible. The environmental effects of these compounds on plants and microbes are as yet largely unknown. Nevertheless, serious efforts to limit the environmental release of PFAS are now commencing.

It may be desirable to have flexibility in terms of what type of approach is used for treating water containing PFAS. For example, the source and/or constituents of the process water to be treated may be a relevant factor. The properties of PFAS compounds may vary widely. Various federal, state and/or municipal regulations may also be factors. The U.S. Environmental Protection Agency (EPA) developed revised guidelines in May 2016 of a combined lifetime exposure of 70 parts per trillion (PPT) for PFOS and PFOA. In June 2022, this EPA guidance was tightened to a recommendation of 0.004 ppt lifetime exposure for PFOA and 0.02 ppt lifetime exposure for PFOS. Federal, state, and/or private bodies may also issue relevant regulations. Market conditions may also be a controlling factor. These factors may be variable and therefore a preferred water treatment approach may change over time.

Use of various adsorption media is one technique for treating water containing PFAS. Activated carbon and ion exchange resin are both examples of adsorption media that may be used to capture PFAS from water to be treated. Such techniques may be used alone or in conjunction.

Conventional activated carbon adsorption systems and methods to remove PFAS from water have shown to be effective on the longer alkyl chain PFAS but have reduced bed lives when treating shorter alkyl chain compounds. Activated carbon treated with a surfactant can have increased bed life. Some conventional anion selective exchange resins have shown to be effective on the longer alkyl chain PFAS but have reduced bed lives when treating shorter alkyl chain compounds.

Membrane processes such as nanofiltration and reverse osmosis have been used for PFAS removal. Normal oxidative processes have heretofore been unsuccessful in oxidizing PFAS. Even ozone has been reported to be an ineffective oxidant. There have been reports of PFAS moieties being destroyed by combined oxidative technologies such as ozone plus UV or use of specialized anodes to selectively oxidize PFAS. Such techniques may be used in conjunction with the various embodiments disclosed herein.

In accordance with one or more embodiments, there is provided systems and methods of treating water containing PFAS. The water may contain at least 10 ppt PFAS, for example, at least 1 ppb PFAS. For example, the waste stream may contain at least 10 ppt-1ppb PFAS, at least 1 ppb-10 ppm PFAS, at least 1 ppb-10 ppb PFAS, at least 1 ppb-1 ppm PFAS, or at least 1 ppm-10 ppm PFAS.

In certain embodiments, the water to be treated may include PFAS with other organic contaminants. One issue with treating PFAS compounds in water is that the other organic contaminants compete with the various processes to remove PFAS. For example, if the level of PFAS is 80 ppb and the background total organic carbon (TOC) is 50 ppm, a conventional

PFAS removal treatment, such as an activated carbon column, may exhaust very quickly. Thus, it may be important to remove TOC prior to treatment to remove PFAS.

Thus, in some embodiments, the systems and methods disclosed herein may be used to remove background TOC prior to treating the water for removal of PFAS. The methods may be useful for oxidizing target organic alkanes, alcohols, ketones, aldehydes, acids, or others in the water. In some embodiments, the water containing PFAS further may contain at least 1 ppm TOC. For example, the water containing PFAS may contain at least 1 ppm-10 ppm TOC, at least 10 ppm-50 ppm TOC, at least 50 ppm-100 ppm TOC, or at least 100 ppm-500 ppm TOC.

In accordance with one or more embodiments, adsorption media is used to remove PFAS from water. In some embodiments, the removal material, e.g., adsorption media, used to remove the PFAS can be any suitable removal material, e.g., adsorption media, that can interact with the PFAS in the water to be treated and effectuate its removal, e.g., by being loaded onto the removal material. Carbon-based removal materials, e.g., activated carbon, and resin media are both widely used for the removal of organic and inorganic contaminates from water sources. For example, activated carbon may be used as an adsorbent to treat water. In some embodiments, the activated carbon may be made from bituminous coal, coconut shell, or anthracite coal. The activated carbon may generally be a virgin or a regenerated activated carbon. In some embodiments, the activated carbon may be a modified activated carbon. The activated carbon may be present in various forms, i.e., a granular activated carbon (GAC) or a powdered activated carbon (PAC).

In accordance with one or more embodiments, GAC may refer to a porous adsorbent particulate material, produced by heating organic matter, such as coal, wood, coconut shell, lignin or synthetic hydrocarbons, in the absence of air, characterized that the generally the granules or characteristic size of the particles are retained by a screen of 50 mesh (50 screen openings per inch in each orthogonal direction).

Without wishing to be bound by any particular theory, PAC typically has a larger surface area for adsorption that GAC and can be agitated and flowed more easily, increasing its effective use.

In some embodiments, the GAC used for adsorption removal of PFAS may be modified to enhance its ability to remove negatively charged species from water, such as deprotonated PFAS. For example, the GAC may be coated in a positively charged surfactant that preferentially interacts with the negatively charged PFAS in solution. The positively charged surfactant maybe a quaternary ammonium-based surfactant, such as cetyltrimethylammonium chloride (CTAC). Various activated carbon media for water treatment are known to those of ordinary skill in the art. In at least some non-limiting embodiments, the media may be an activated carbon as described in U.S. Pat. Nos. 8,932,984 and/or 9,914,110, both to Evoqua Water Technologies LLC, the entire disclosure of each of which is hereby incorporated herein by reference in its entirety for all purposes.

In some embodiments, separation of PFAS from a source of contaminated water may be achieved using an adsorption process, where the PFAS are physically captured in the pores of a porous material (i.e., physisorption) or have favorable chemical interactions with functionalities on a filtration medium (i.e., chemisorption). In accordance with one or more embodiments, a PFAS separation stage may include adsorption onto an electrochemically active substrate. An example of an electrochemically active substrate that can be used to adsorb PFAS is granular activated carbon (GAC). Adsorption onto GAC, compared to other PFAS separation methods, is a low-cost solution to remove PFAS from water that can potentially avoid known issues with other removal methods, such as the generation of large quantities of hazardous regeneration solutions of ion exchange vessels and the lower recovery rate and higher energy consumption of membrane-based separation methods such as nanofiltration and reverse osmosis (RO).

The removal material as described herein is not limited to particulate media, e.g., activated carbons, or cyclodextrins. Any suitable removal material, e.g., adsorption media, may be used to adsorb or otherwise bind with pollutants and contaminants present in the waste stream, e.g., PFAS. For example, suitable removal material may include, but are not limited to, alumina, e.g., activated alumina, aluminosilicates and their metal-coordinated forms, e.g., zeolites, silica, perlite, diatomaceous earth, surfactants, ion exchange resins, and other organic and inorganic materials capable of interacting with and subsequently removing contaminants and pollutants from the waste stream.

In certain non-limiting embodiments, this disclosure describes water treatment systems for removing PFAS from water and methods of treating water containing PFAS. Systems described herein include a contact reactor containing a removal material, e.g., an adsorption media, that has an inlet fluidly connected to a source of water containing PFAS. The removal material, after being exposed to PFAS and removing it from the water, may become loaded with PFAS. Treated water, i.e., water containing a lower concentration of PFAS than the source water may be separated from the removal material, e.g., adsorption media. The contact reactor may then be placed into a cleaning mode as discussed herein for further processing of the loaded adsorption media. In accordance with one or more embodiments, loaded adsorption media, e.g. granular activated carbon (GAC) or ion exchange resin, may be further processed as disclosed further herein.

In some embodiments, the dosage of adsorption media may be adjusted based on at least one quality parameter of the water to be treated. For example, the at least one quality parameter may include a target concentration of the PFAS in the treated water to be at or below a specified regulatory threshold.

In accordance with one or more embodiments, a water treatment system may include a source of water connectable by conduit to an inlet of an upstream separation system that can produce a treated water and a stream enriched in PFAS. This upstream separation system may thus concentrate the water to be treated with respect to its PFAS content. A first separation system can be any suitable separation system that can produce a stream enriched in PFAS or other compounds. For example, the upstream separation system can be a membrane concentrator with an optional dynamic membrane, reverse osmosis (RO) system, a nanofiltration (NF) system, an ultrafiltration system (UF), or electrochemical separations methods, e.g., electrodialysis, electrodeionization, etc. In such implementations, the reject, retentate or concentrate streams from these types of separation systems will include water enriched in PFAS. For example, the concentration increase of PFAS in the water upon concentrating may be at least 20× relative to the initial concentration of PFAS before concentration, e.g., at least 20×, at least 25×, at least 30×, at least 35×, at least 40×, at least 45×, at least 50×, at least 55×, at least 60×, at least 65×, at least 70×, at least 75×, at least 80×, at least 85×, at least 90×, at least 95×, or at least 100×. In some embodiments of the system, water from the source of water, or another source of PFAS containing water, can be directed into the contact reactor via conduit without the need for upstream separation to produce a stream of water enriched in PFAS. In other embodiments, water from an upstream concentration process may be directed to the contact reactor.

The treated water produced by the system downstream of the contact reactor may be substantially free of the PFAS. The treated water being “substantially free” of the PFAS may have at least 90% less PFAS by volume than the waste stream. The treated water being substantially free of the PFAS may have at least 92% less, at least 95% less, at least 98% less, at least 99% less, at least 99.9% less, or at least 99.99% less PFAS by volume than the waste stream. Thus, in some embodiments, the systems and methods disclosed herein may be employed to remove at least 90% of PFAS by volume from the source of water. The systems and methods disclosed herein may remove at least 92%, at least 95%, at least 98%, at least 99%, at least 99.9%, or at least 99.99% of PFAS by volume from the source of water. In certain embodiments, the systems and methods disclosed herein are associated with a PFAS removal rate of at least about 99%, e.g., about 99%, about 99.1%, about 99.2%, about 99.3%, about 99.4%, about 99.5%, about 99.6%, about 99.7%, about 99.8%, about 99.9%, about 99.95%, or about 99.99%.

In accordance with one or more embodiments, an eluent may be introduced to PFAS-loaded removal material, e.g., adsorption media such as GAC or ion exchange resin, to produce a waste stream containing PFAS. The eluent may be introduced to a contact reactor in a cleaning mode once the adsorption media becomes loaded. Breakthrough may be one indication of excess loading. The cleaning may otherwise be performed for maintenance periodically.

In accordance with one or more embodiments, PFAS may be eluted off the GAC or ion exchange resin by the use of an eluent to form a waste stream containing PFAS. The eluent may be any compound suitable for releasing PFAS from the adsorption media. The eluent may be a water-soluble volatile compound. An example of an eluent would be cyclodextrin. The eluent can be a volatile compound such as a hydrocarbon. In some embodiments, the eluent may be a flammable solvent, e.g. alcohol or organic compound, e.g. methanol. In other embodiments, the eluent may be supercritical carbon dioxide. The invention is not limited to the type of eluent.

After the PFAS is eluted off the adsorption media, the adsorption media, if not adequately-regenerated through the elution process for direct reuse back into the treatment system, may be reactivated or further regenerated for reuse, or instead destroyed. For example, GAC may be reactivated using heated kilns operating at temperatures of about 875° C. to 1000° C. (or even higher). Alternatively, the GAC may be regenerated using solvents, or further regenerated using treatment with multicomponent mixtures and additives comprising supercritical carbon dioxide. Ion exchange resins can be regenerated using typical ion exchange regenerants, regenerants using amine surfactants, or regenerants comprising multicomponent mixtures and additives comprising supercritical carbon dioxide. In other embodiments, ion exchange resins can be mineralized via incineration. Examples of such processes are disclosed in U.S. Provisional Patent Application No. 63/432,614, U.S. Provisional Patent Application No. 63/358,249, and PCT Patent Application No. PCT/US2022/051183, all owned by Applicant which are hereby incorporated herein by reference in their entireties for all purposes.

In accordance with one or more embodiments, carbon reactivation includes a method of thermally processing activated carbon, to remove adsorbed components contained within its pores without substantial damage to the original porosity of the carbon. Carbon reactivation is commonly performed by subjecting the carbon to elevated temperatures typically but not limited to temperatures of 700° C. to 800° C. in a controlled atmosphere including water vapor in a rotating kiln or multiple hearth furnace. It can be distinguished from carbon regeneration which may utilize solvents, chemicals, steam, or wet oxidation processes for removal of adsorbed components. During the reactivation process approximately 5% to 10% of the original carbon is reduced to carbon fines or is vaporized.

In some embodiments, the eluted waste stream containing PFAS may be concentrated prior to further processing. In other embodiments, it may be further processed directly. A foam fractionation process or other approach may be used to concentrate the waste stream. By example, removing ppt levels of PFAS onto GAC may concentrate the PFAS onto the media by several orders of magnitude, and the eluted waste stream can then be concentrated further such as via foam fractionation by several additional orders of magnitude, with PFAS concentrations increasing by example from ppt levels up to ppb or even ppm levels to enable further treatment or destruction.

In accordance with one or more embodiments, foam fractionation may also be used for concentration of the source water upstream of the adsorption media. In foam fractionation, foam produced in water generally rises and removes hydrophobic molecules from the water. Foam fractionation has typically been utilized in aquatic settings, such as aquariums, to remove dissolved proteins from the water. During foam fractionation, gas bubbles rise through a vessel of contaminated water, forming a foam that has a large surface area air-water interface with a high electrical charge. The charged groups on PFAS molecules adsorb to the bubbles of the foam and form a surface layer enriched in PFAS that can subsequently be removed. The bubbles may be formed using any suitable gas, such as compressed air or nitrogen. In some embodiments, the bubbles are formed from an oxidizing gas, such as ozone to aid in preventing competing compounds such as metals or other organics from affecting PFAS removal, which competing compounds are likely to be in much larger concentrations than PFAS. Foam fractionation systems useful for the invention are known in the art. Multiple stages may be incorporated into a foam fractionation process. Each stage will further concentrate the PFAS compounds which also results in a smaller volume of liquid. It is possible to reduce the volume by more than 99% and increase the concentration by over 200 times using foam fractionation processes. PCT publication WO2019111238 is hereby incorporated herein by reference in its entirety for all purposes.

In accordance with one or more embodiments, a pH level of the eluent and/or waste stream may be adjusted to a level of about 7 or greater prior to further processing. The eluent or spent eluent feeding the ICE may be pH adjusted to a level of about 7 or greater, for example via addition of ammonium hydroxide or sodium hydroxide.

In accordance with one or more embodiments, there is provided a method of treating water containing PFAS. The method may include dosing water containing PFAS with adsorption media to promote loading of the adsorption media with PFAS. The method further may include producing a waste stream including PFAS. In some embodiments, the PFAS include one or more PFOS and PFOA. The waste stream containing PFAS may be processed as described herein.

In accordance with one or more embodiments, the waste stream containing PFAS may be directed to an internal combustion engine (ICE) to promote mineralization of the PFAS via combustion. A source of oxygen and a source of fuel may be provided. In some embodiments, the waste stream may be included in a fuel or air stream for intake into an internal combustion engine, thereby incorporating the volatile vapors into the fuel/air combustion process. In some non-limiting embodiments, the waste stream may be atomized into the internal combustion engine. The internal combustion engine may be constructed and arranged to operate at various process temperatures which may depend on the type of fuel employed. Various sources of fuel may comprise natural gas, propane, propene, gasoline, diesel fuel or bio-diesel fuel. The source of fuel may be supplemented to inhibit corrosion of cylinders associated with the internal combustion engine. In at least some embodiments, ammonia may be added to the source of fuel. In some embodiments, the internal combustion engine may be operated at a process temperature of at least about 1000° C. In at least some embodiments, the internal combustion engine may be operated at a process temperature of at least about 1500° C. The internal combustion engine may be constructed and arranged to operate at a process temperature in the range of about 1000° C. to about 2000° C. The internal combustion engine may be constructed and arranged to provide a residence time which exceeds a PFAS destruction requirement.

Such an internal combustion engine is disclosed in U.S. Pat. No. 5,424,045, the disclosure of which is incorporated herein by reference in its entirety. Internal combustion engines are also disclosed in U.S. Pat. Nos. 9,523,330, 9,777,675, 9,885,317 and 10,138,845 all owned by Applicant which are hereby incorporated herein by reference in their entireties for all purposes.

The internal combustion engine may destroy PFAS compounds by introducing a liquid possibly atomized into an internal combustion engine so that PFAS is mineralized in the fuel/air combustion process. The temperature of operation of an internal combustion engine using a hydrocarbon-based fuel can be over 1000° C. For example, CNG (Compressed Natural Gas) has a peak flame temperature of 1790° C. which is 187° C. or 9.5% cooler than the peak flame temperature of gasoline at 1977° C. The peak flame temperature of propane at 1991° C. is only 13° C. or about 1% higher than gasoline. A Diesel engine can have an operating temperature of over 2500° C. due to the greater operating pressure. An internal combustion engine (4 stroke) using gasoline may have a compression ratio of about 9:1. A Diesel engine may have a compression ratio of 20:1 or greater which accounts for the greater combustion temperature.

Once the adsorption column has reached the capacity to remove PFAS, it may be placed in a cleaning mode. An eluent is directed through the GAC column which results in a waste stream that comprises PFAS and the eluent. The waste stream is directed to a thermal destruction process or an internal combustion engine (ICE). A source of oxygen containing gas such as air and a source of fuel are both introduced to the ICE. The ICE is operated so that the fuel/air mixture undergoes combustion. The temperature of the combustion process mineralizes the PFAS.

In accordance with one or more embodiments, the operation of the ICE results in an axial motion of a drive shaft which may beneficially be used to drive an electric generator. The resulting electricity may be used to operate the ancillary equipment of the system or directed to the electric grid.

In some embodiments, the source of oxygen containing gas may be derived from a gas separation process. The source of oxygen may be enriched. This process with increase the concentration of oxygen in air from about 21% to as much as 99%. Using enriched oxygen for the ICE combustion will make the combustion more efficient and also reduce the formation of oxides of nitrogen (NOx) which causes air pollution. One such gas separation process is the PRISM gas separation module from Air Products, Allentown, PA. The ICE may comprise a four-stroke engine using a fuel source that comprises a hydrocarbon such as propane or gasoline. The type of fuel used is non-limiting. The ICE may comprise a Diesel engine that uses diesel fuel or bio-diesel fuel as the fuel source.

In accordance with one or more embodiments, the exhaust from the ICE may be directed to a catalytic converter and/or polished downstream as described herein. A thermal oxidizer or a polishing sorbent unit operation may be positioned downstream of the ICE for exhaust polishing. In accordance with one or more embodiments, the process without the optional polishing stage may eliminate 99.99% of the PFAS and other organic compounds, so the polishing stage can get product emissions below detection limits.

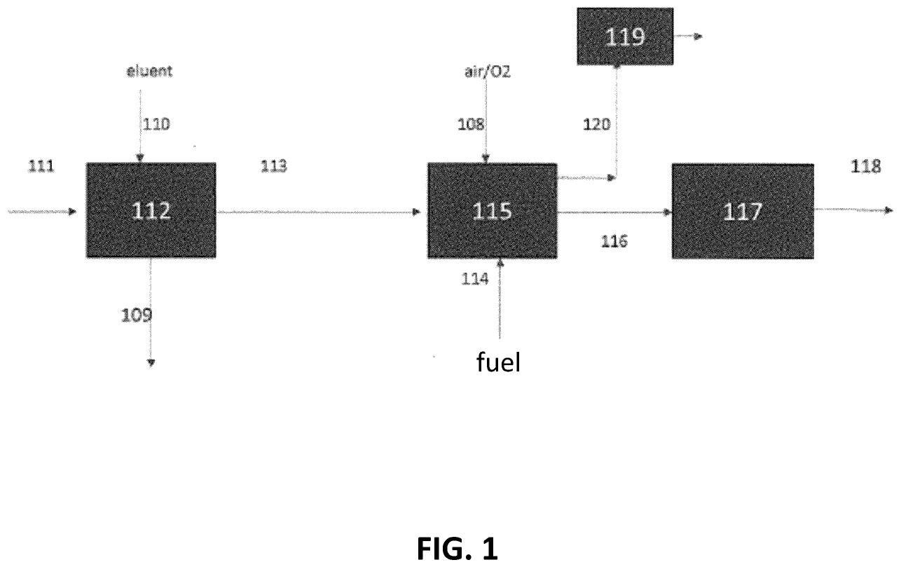

Referring to FIG. 1, a source of PFAS contaminated water 111 is directed to a column 112 of GAC. The GAC removes the PFAS through adsorption resulting in water with a reduced concentration of PFAS compared to the feed water. The clean water 109 has been decontaminated of PFAS. Once the GAC column 112 has reached the capacity to remove PFAS, it is placed in a cleaning mode. An eluent 110 is directed through the GAC column 112 which results in a waste stream 113 that comprises PFAS and the eluent. The waste stream 113 is directed to an internal combustion engine (ICE) 115. A source of oxygen containing gas such as air 108 and a source of fuel 114 are both introduced to the ICE. The ICE is operated so that the fuel/air mixture undergoes combustion. The temperature of the combustion process mineralizes the PFAS. The exhaust 120 from the ICE is directed to a catalytic converter 119. The operation of the ICE results in an axial motion of a drive shaft 116 which is used to drive an electric generator 117. The resulting electricity 118 is used to operate the ancillary equipment of the system or directed to the electric grid. The eluent can be a volatile compound such as a hydrocarbon. An alcohol such as methanol would be an example. Any water-soluble volatile compound may be suitable including other alcohols and organic compounds. The eluent could be cyclodextrin. This invention is not limited to the type of eluent.

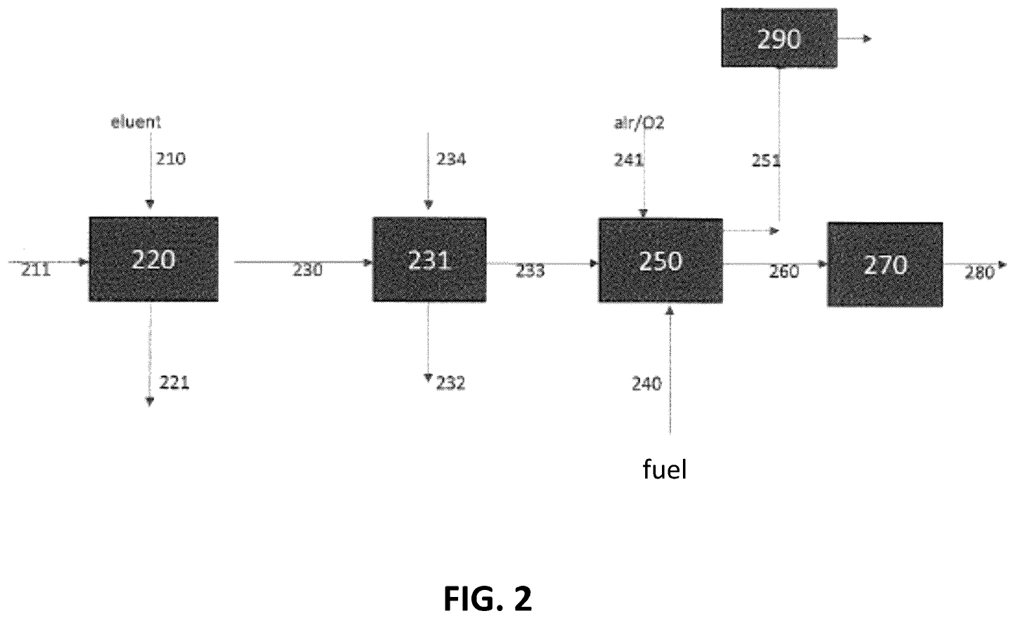

Referring to FIG. 2, a source of PFAS contaminated water 211 is directed to a column 220 of GAC. The GAC removes the PFAS through adsorption resulting in water with a reduced concentration of PFAS compared to the feed water. The clean water 221 has been decontaminated of PFAS. Once the GAC column 220 has reached the capacity to remove PFAS, it is placed in a cleaning mode. An eluent 210 is directed through the GAC column 220 which results in a waste stream 230 that comprises PFAS and eluent. The waste stream 230 is directed to a foam fractionation process (FF) 231. A source of gas 234 is introduced to the FF 231 resulting in a froth layer 233 containing PFAS and a clean water effluent 232. The FF 231 will concentrate the PFAS containing liquid. The FF 231 may comprise several stages which further concentrates the PFAS in the froth layer 233. The froth layer 233 is directed to an internal combustion engine (ICE) 250. A source of oxygen containing gas such as air 241 and a source of fuel 240 are both introduced to the ICE. The ICE is operated so that the fuel/air mixture undergoes combustion. The temperature of the combustion process mineralizes the PFAS. The exhaust 251 from the ICE is directed to a catalytic converter 290. The operation of the ICE results in an axial motion of a drive shaft 260 which is used to drive an electric generator 270. The resulting electricity 280 is used to operate the ancillary equipment of the system or directed to the electric grid.

In some embodiments, systems and methods disclosed herein can be designed for centralized applications, onsite application, or mobile applications via transportation to a site. The centralized configuration can be employed at a permanent processing plant such as in a permanently installed water treatment facility such as a municipal water treatment system. The onsite and mobile systems can be used in areas of low loading requirement where temporary structures are adequate. A mobile unit may be sized to be transported by a semi-truck to a desired location or confined within a smaller enclosed space such as a trailer, e.g., a standard 53′ trailer, or a shipping container, e.g., a standard 20′ or 40′ intermodal container.

Beneficially, material containing PFAS need not be transported across a relatively far distance in accordance with various embodiments. Localized removal and destruction is enabled herein.

The function and advantages of these and other embodiments can be better understood from the following example. This example is intended to be illustrative in nature and is not considered to be in any way limiting the scope of the invention.

### Prophetic Example

It has generally been reported that thermal destruction of PFAS occurs in two to four seconds at 600 to 1000 C. Assuming operation of a propane internal combustion engine at 600 rpm or 10 rps, the residence time in the engine would be roughly 0.1 seconds or at least 25 times more time that destruction requirement of PFAS.

Internal combustion temperatures in the cylinders reach temperatures over 1500 C and with propane, the flame temperature can reach over 1900 C. Assuming doubling of oxidation rate for every 10 C above 1000 C, that would increase the destruction rate by a factor of 1000 for every 100 C over 1000 C. With a very great safety factor and assume four seconds to destruction at 1000 C, the time to destruction at engine cylinder temperatures would be less than 0.004 seconds.

Further, because of cylinder cooling the cylinders may operate at about 250 C, which would be a lower enough temperature such that any undestroyed PFAS vapor would plate out on the surface of the cylinder and have an even larger residence time for further destruction.

The feed gas can be adjusted with a gas such as ammonia to eliminate potential corrosion of the cylinders. Likewise, a flammable eluent may be selected in order to facilitate combustion.

The eluent or spent eluent feeding the ICE may be pH adjusted to a level of about 7 or greater, for example via addition of ammonium hydroxide or sodium hydroxide.

As a polisher to the offgas, the ICE treatment can be followed with a thermal oxidizer as added protection against an PFAS vapor emissions. In this case because of potential fouling of catalyst in a catalytic oxidizer by fluorides, a regenerative thermal oxidizer can be used. The thermal oxidizer may buffer the pH upward and prevent corrosion from halogens mineralized during the PFAS destruction or present in the feed. A polishing sorbent step may also be implemented.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

1. A method of treating water containing a per- or poly-fluoroalkyl substance (PFAS), comprising:
introducing water containing PFAS to an adsorption media to promote loading of the adsorption media with PFAS;
introducing an eluent to the adsorption media containing PFAS to produce a waste stream containing PFAS; and
directing the waste stream containing PFAS to an internal combustion engine with a source of oxygen and a source of fuel to promote mineralization of the PFAS.

2. The method of claim 1, wherein the PFAS comprises perfluorooctane sulfonic acid (PFOS), perfluorooctanoic acid (PFOA), or a perfluoroalkyl ether carboxylic acid.

3. The method of claim 1, wherein the internal combustion engine is operated at a process temperature of at least about 1000° C.

4. The method of claim 3, wherein the internal combustion engine is operated at a process temperature of at least about 1500° C.

5. The method of claim 1, wherein the adsorption media comprises granular activated carbon (GAC).

6. The method of claim 5, wherein the adsorption media is coated with a positively charged surfactant.

7. The method of claim 1, wherein the adsorption media comprises ion exchange resin.

8. The method of claim 1, further comprising reactivating or regenerating the adsorption media.

9. (canceled)

10. The method of claim 1, further comprising concentrating or dewatering the waste stream containing PFAS prior to directing the waste stream to the internal combustion engine.

11. The method of claim 10, wherein the waste stream is subjected to a foam fractionation process.

12. The method of claim 1, wherein the waste stream containing PFAS is atomized into the internal combustion engine.

13. The method of claim 1, further comprising adjusting a pH level of the eluent or the waste stream to a level of greater than about 7 upstream of the internal combustion engine.

14. The method of claim 1, wherein the eluent is a water-soluble volatile compound.

15. The method of claim 14, wherein the eluent is a cyclodextrin.

16. The method of claim 1, wherein the eluent is supercritical carbon dioxide.

17. The method of claim 1, wherein the eluent is a flammable solvent.

18. The method of claim 17, wherein the flammable solvent comprises methanol.

19. The method of claim 1, further comprising directing an exhaust stream associated with the internal combustion engine to a catalytic converter.

20. The method of claim 1, further comprising polishing an exhaust stream associated with the internal combustion engine.

21. The method of claim 20, wherein polishing comprises directing the exhaust stream to a thermal oxidizer or a polishing sorbent unit operation.

22-40. (canceled)
